(19) United States
(12) Patent Application Publication
(10) Pub. No.: US 2025/0065899 A1
(43) Pub. Date: Feb. 27, 2025

(54) MISBEHAVIOR DETECTION AND INTERVENTION

(71) Applicant: GM Global Technology Operations LLC, Detroit, MI (US)

(72) Inventors: Arun Adiththan, Sterling Heights, MI (US); Md Mhafuzul Islam, Warren, MI (US); Prakash M. Peranandam, Rochester Hills, MI (US); Ramesh Sethu, Troy, MI (US)

(21) Appl. No.: 18/455,103

(22) Filed: Aug. 24, 2023

(51) Int. Cl. B60W 50/14; E05B 81/56; G08B 31/00

(52) U.S. Cl. CPC B60W 50/14; E05B 81/56; G08B 31/00; B60W 2050/146

(57) ABSTRACT

A system for monitoring misbehavior of neighboring vehicles and initiating interventions within a vehicle includes a plurality of onboard vehicle sensors in communication with a system controller, the system controller adapted to identify at least one neighboring vehicle, tag the at least one neighboring vehicle with a unique identifier, monitor, with the plurality of onboard sensors, driving patterns of the at least one neighboring vehicle, classify the at least one neighboring vehicle, and initiate intervention action.

### INTRODUCTION

The present disclosure relates to a system and method for monitoring the behavior of neighboring vehicles and initiating intervention actions based on such behavior.

Vehicles are equipped with many sensors to monitor the environment surrounding the vehicle, and to provide warnings when objects get to close, etc. However, current systems are limited in that they provide alerts or take action only when imminent danger of collision is detected. Driver's of vehicles are exposed to misbehavior by other vehicles that would not trigger current systems.

Thus, while current systems and methods achieve their intended purpose, there is a need for a new and improved system and method for detecting misbehavior in neighboring vehicles, such as aggressive or stalking behavior, and initiating intervention action based on the type of misbehavior, severity of the misbehavior and preferences of an occupant.

### SUMMARY

According to several aspects of the present disclosure, a method of monitoring misbehavior of neighboring vehicles and initiating interventions by a vehicle includes identifying, with a plurality of onboard vehicle sensors in communication with a system controller, at least one neighboring vehicle, tagging, with the system controller, the at least one neighboring vehicle with a unique identifier, monitoring, with the plurality of onboard sensors in communication with the system controller, driving patterns of the at least one neighboring vehicle, classifying, with the system controller, the at least one neighboring vehicle, and initiating, with the system controller, intervention action.

According to another aspect, the monitoring, with the plurality of onboard sensors in communication with the system controller, driving patterns of the at least one neighboring vehicle further includes monitoring, with the plurality of onboard sensors: a relative distance of the at least one neighboring vehicle, a relative position of the at least one neighboring vehicle, a relative speed of the at least one neighboring vehicle, and a heading direction of the at least one neighboring vehicle.

According to another aspect, the monitoring, with the plurality of onboard sensors in communication with the system controller, driving patterns of the at least one neighboring vehicle further includes periodically fusing, with the system controller, data from the plurality of onboard sensors, and constructing, with the system controller, a time-series datapoint.

According to another aspect, the classifying, with the system controller, the at least one neighboring vehicle further includes identifying, with the system controller, a pattern of behavior of the at least one neighboring vehicle, and probabilistically classifying, with a machine learning algorithm within the system controller, the pattern of behavior of the at least one neighboring vehicle as one of nominal, aggressive, and stalking.

According to another aspect, the probabilistically classifying, with a machine learning algorithm within the system controller, the pattern of behavior of the at least one neighboring vehicle as one of nominal, aggressive, and stalking further includes, when the pattern of behavior of the at least one neighboring vehicle is probabilistically classified as either one of aggressive or stalking, calculating, with the system controller, a severity level of the pattern of behavior.

According to another aspect, when the severity level of the pattern of behavior exceeds a first pre-determined threshold, the initiating, with the system controller, intervention action further includes initiating, with the system controller, passive intervention action.

According to another aspect, the initiating, with the system controller, passive intervention action further includes at least one of informing, via a vehicle human machine interface (HMI) in communication with the system controller, an occupant within the vehicle of the identification, by the system controller, of the at least one neighboring vehicle that has been classified as either one of aggressive or stalking, capturing, with the plurality of onboard sensors, images of the at least one neighboring vehicle and images of a license plate of the at least one neighboring vehicle, capturing, with the plurality of onboard sensors, images of a driver of the neighboring vehicle, collect, with the plurality of onboard sensors, attributes of the at least one neighboring vehicle and attributes of the driver of the at least one neighboring vehicle, locking doors of the vehicle, and closing windows of the vehicle.

According to another aspect, when the severity level of the pattern of behavior exceeds a second pre-determined threshold, the initiating, with the system controller, intervention action further includes initiating, with the system controller, active intervention action.

According to another aspect, the initiating, with the system controller, active intervention action further includes at least one of alerting, with the system controller, via a wireless communication module, emergency services, alerting, with the system controller, via the wireless communication module, emergency contacts, providing, with the system controller, via the HMI, suggested navigation actions, and autonomously executing, with a vehicle control module in communication with the system controller, navigation actions.

According to another aspect, the method further includes receiving, with the system controller, via the HMI, preferences of the occupant within the vehicle related to the first and second pre-determined thresholds, and setting the first and second pre-determined thresholds based on preferences of the occupant.

According to several aspects of the present disclosure, a system for monitoring misbehavior of neighboring vehicles and initiating interventions within a vehicle includes a plurality of onboard vehicle sensors in communication with a system controller, the system controller adapted to identify at least one neighboring vehicle, tag the at least one neighboring vehicle with a unique identifier, monitor, with the plurality of onboard sensors, driving patterns of the at least one neighboring vehicle, classify the at least one neighboring vehicle, and initiate intervention action.

According to another aspect, when monitoring, with the plurality of onboard sensors, driving patterns of the at least one neighboring vehicle the system controller is further adapted to monitor, with the plurality of onboard sensors, a relative distance of the at least one neighboring vehicle, a relative position of the at least one neighboring vehicle, a relative speed of the at least one neighboring vehicle, and a heading direction of the at least one neighboring vehicle.

According to another aspect, when monitoring, with the plurality of onboard sensors, driving patterns of the at least one neighboring vehicle, the system controller is further adapted to periodically fuse data from the plurality of onboard sensors, and construct a time-series datapoint.

According to another aspect, when classifying the at least one neighboring vehicle, the system controller is further adapted to Identify a pattern of behavior of the at least one neighboring vehicle, and probabilistically classify, with a machine learning algorithm within the system controller, the pattern of behavior of the at least one neighboring vehicle as one of nominal, aggressive, and stalking.

According to another aspect, when probabilistically classifying the pattern of behavior of the at least one neighboring vehicle, and when the pattern of behavior of the at least one neighboring vehicle is probabilistically classified as either one of aggressive or stalking, the system controller is further adapted to calculate a severity level of the pattern of behavior.

According to another aspect, when the severity level of the pattern of behavior exceeds a first pre-determined threshold, the system controller is further adapted to initiate passive intervention action, wherein the first pre-determined threshold is set according to preferences received from an occupant within the vehicle via a vehicle human machine interface (HMI) in communication with the system controller.

According to another aspect, when initiating passive intervention action, the system controller is further adapted to at least one of inform, via the HMI in communication with the system controller, the occupant within the vehicle of the identification, by the system controller, of the at least one neighboring vehicle that has been classified as either one of aggressive or stalking, capture, with the plurality of onboard sensors, images of the at least one neighboring vehicle, images of a license plate of the at least one neighboring vehicle, and images of a driver of the neighboring vehicle, collect, with the plurality of onboard sensors, attributes of the at least one neighboring vehicle and attributes of the driver of the at least one neighboring vehicle, lock doors of the vehicle, and close windows of the vehicle.

According to another aspect, when the severity level of the pattern of behavior exceeds a second pre-determined threshold, the system controller is further adapted to initiate active intervention action, wherein the second pre-determined threshold is set according to preferences received from the occupant within the vehicle via the HMI.

According to another aspect, when initiating active intervention action the system controller is further adapted to at least one of alert, via a wireless communication module, emergency services and emergency contacts, provide, via the HMI, suggested navigation actions, and autonomously execute, with a vehicle control module in communication with the system controller, navigation actions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle having a system for monitoring misbehavior of neighboring vehicles and initiating intervention action according to an exemplary embodiment;

FIG. 2 is a schematic diagram of the system according to an exemplary embodiment;

FIG. 3 is a schematic diagram illustrating the vehicle shown in FIG. 1 and multiple neighboring vehicles traveling on a roadway;

FIG. 4 is a flow chart illustrating an example of monitoring tailgating behavior of a neighboring vehicle and initiating intervention actions;

FIG. 5 is a flow chart illustrating an example of monitoring stalking behavior of a neighboring vehicle and initiating intervention actions; and

FIG. 6 is a flow chart illustrating a method of monitoring misbehavior of at least one neighboring vehicle and initiating intervention actions according to an exemplary embodiment.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

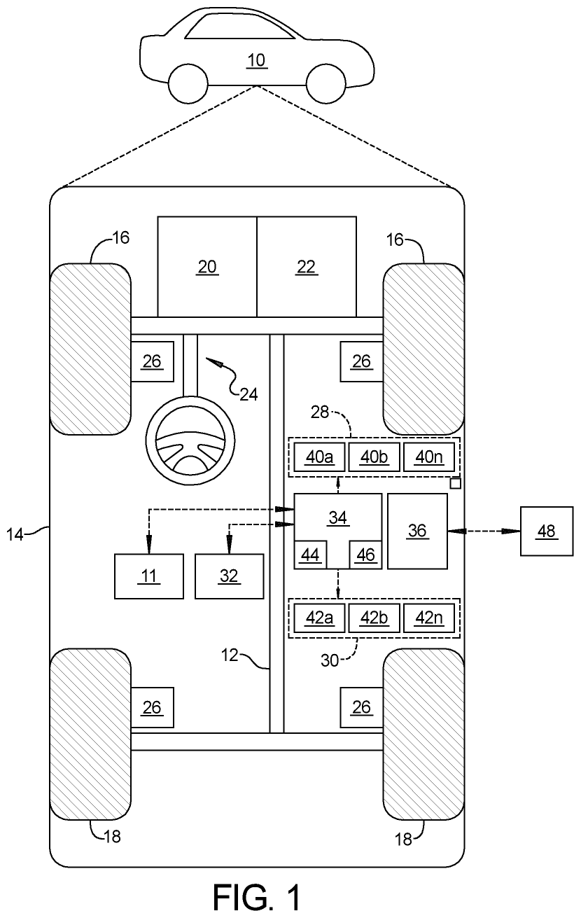

In accordance with an exemplary embodiment, FIG. 1 shows an electric vehicle 10 with an associated system 11 for monitoring misbehavior of neighboring vehicles and initiating interventions in accordance with various embodiments. In general, the system 11 works in conjunction with other systems within the vehicle 10 to display various information and infotainment content for the passenger. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the system 11 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles, wherein misbehavior detection and intervention capabilities are limited, but can still be implemented. For example, detection can be carried out through ultrasound and camera sensors, however, a non-autonomous vehicle would not have the capability of taking over control of the vehicle 10, so the options for intervention are limited.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. In another exemplary embodiment, at least one of the plurality of sensing devices 40a-40n is capable of measuring distances in the environment surrounding the vehicle 10.

In a non-limiting example wherein the plurality of sensing devices 40a-40n includes a camera, the plurality of sensing devices 40a-40n measures distances using an image processing algorithm configured to process images from the camera and determine distances between objects. In another non-limiting example, the plurality of vehicle sensors 40a-40n includes a stereoscopic camera having distance measurement capabilities. In one example, at least one of the plurality of sensing devices 40a-40n is affixed inside of the vehicle 10, for example, in a headliner of the vehicle 10, having a view through the windshield of the vehicle 10. In another example, at least one of the plurality of sensing devices 40a-40n is affixed outside of the vehicle 10, for example, on a roof of the vehicle 10, having a view of the environment surrounding the vehicle 10. It should be understood that various additional types of sensing devices, such as, for example, LiDAR sensors, ultrasonic ranging sensors, radar sensors, and/or time-of-flight sensors are within the scope of the present disclosure. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the vehicle controller 34 are embodied in a trajectory planning system and, when executed by the at least one data processor 44, generates a trajectory output that addresses kinematic and dynamic constraints of the environment. For example, the instructions receive as input process sensor and map data. The instructions perform a graph-based approach with a customized cost function to handle different road scenarios in both urban and highway roads.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

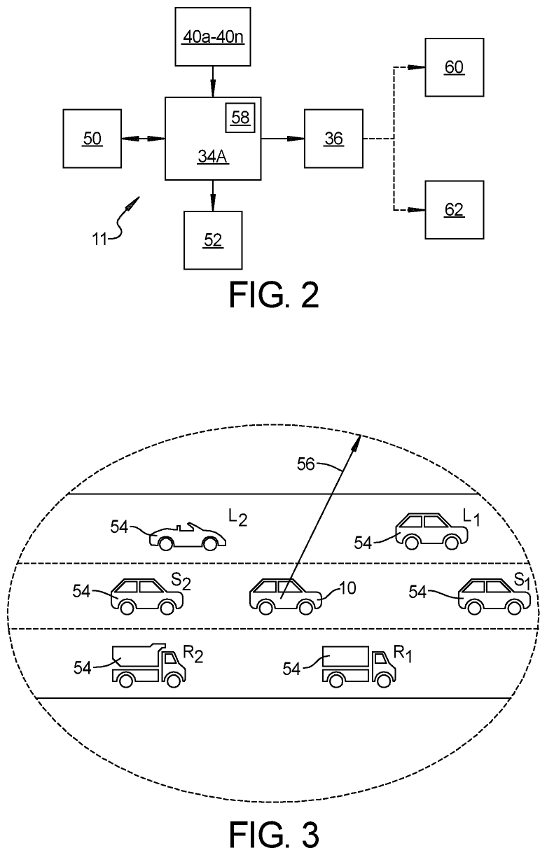

Referring to FIG. 2 a schematic diagram of the system 11 is shown. The system 11 includes a system controller 34A in communication with the plurality of sensing devices (onboard sensors) 40a-40n. The system controller 34A may be the vehicle controller 34, or the system controller 34A may be a separate controller in communication with the vehicle controller 34. In addition to the plurality of onboard sensors 40a-40n, the system controller 34A is in communication with a human machine interface (HMI) 50, a vehicle control module (VCM) 52 and the wireless communication module 36.

The system controller 34A is adapted to identify at least one neighboring vehicle 54. A neighboring vehicle 54 is a vehicle that is within a certain distance 56 of the vehicle 10. The distance 56 at which a neighboring vehicle 54 must be is based on the plurality of onboard sensors 40a-40n and the distance at which most of such onboard sensors 40a-40n will be able to monitor the neighboring vehicle 54. Thus, only vehicles that are close enough to be monitored by multiple sensing devices 40a-40n and multiple types of sensing devices 40a-40n will be considered a neighboring vehicle 54.

As shown in FIG. 2, the plurality of onboard sensors 40a-40n have detected six neighboring vehicles 54. The system controller 34A is further adapted to tag the at least one neighboring vehicle 54 with a unique identifier. As shown in FIG. 2, the system controller 34A has tagged each of the six neighboring vehicles 54 with a unique identifier. Thus, two neighboring vehicles 54 that are in the lane adjacent the vehicle 10 on the left are designated as “L₁” and “L₂”, two neighboring vehicles 54 that are traveling in the same lane as the vehicle 10 are designated as “S₁” and “S₂”, and two neighboring vehicles 54 that are traveling in the lane adjacent the vehicle 10 on the right are designated as “R₁” and “R₂”.

The system controller 34A is further adapted to monitor, with the plurality of onboard sensors 40a-40n, driving patterns of the at least one neighboring vehicle 54, classify the at least one neighboring vehicle 54, and initiate intervention action when appropriate. When monitoring driving patterns of the at least one neighboring vehicle 54 the system controller 34A is further adapted to monitor, with the plurality of onboard sensors 40a-40n, a relative distance (from the vehicle 10) of the at least one neighboring vehicle 54, a relative position (left lane, same lane, right lane, etc.) of the at least one neighboring vehicle 54, a relative speed of the at least one neighboring vehicle 54, and a heading direction of the at least one neighboring vehicle 54. Data is collected by the plurality of onboard sensors 40a-40n for each of the identified neighboring vehicles 54 (L₁, L₂, S₁, S₂, R₁, R₂) on a periodic basis. For example, in an exemplary embodiment, data is collected by the plurality of onboard sensors 40a-40n for each of the identified neighboring vehicles 54 ten times every second, or ten Hz. Each time data is collected, the system controller 34A is adapted to fuse data from the plurality of onboard sensors 40a-40n for each of the identified neighboring vehicles 54 and to construct a time-series datapoint for each of the identified neighboring vehicles 54, given as [timestamp, vehicle_id, relative_dist, relative_pos, relative_speed].

When classifying the at least one neighboring vehicle 54, the system controller 34A is further adapted to identify a pattern of behavior of the at least one neighboring vehicle 54, and to probabilistically classify, with a machine learning algorithm 58 within the system controller 34A, the pattern of behavior of the at least one neighboring vehicle 54 as one of nominal, aggressive, and stalking. For each of the identified neighboring vehicles 54, the system controller 34A analyzes the time-series datapoints to look for identifiable patterns. For example, such patterns may indicate that the driving behavior of a neighboring vehicle 54 has been nominal, or that the relative distance between the vehicle 10 and a neighboring vehicle 54 has been less than a safe distance for an extended period of time, indicating possible aggressive behavior such as tailgating, or that a neighboring vehicle 54 has been following the vehicle 10 for some time and between various destinations, indicating possible stalking behavior. Other identifiable signs of misbehavior of a neighboring vehicle are, for example, weaving, tailgating, failing to signal lane changes, and frequent lane changes.

Key indicators of stalking behavior include frequent appearances of the same vehicle or driver near the vehicle's 10 location, even in different areas or at varying times. Stalkers often engage in repeated patterns when targeting their victims. These patterns might include following the victim's vehicle at regular intervals or repeatedly parking nearby. Observation of such patterns allows the machine learning algorithm to establish a pattern of behavior, and to classify such pattern as stalking.

To create the machine learning algorithm 58, a diverse dataset is collected from vehicles equipped with sensors such as GPS, accelerometers, cameras, radar, and LIDAR. The data encompasses various driving scenarios, including urban, highway, and off-road driving. Before feeding the data into machine learning models, preprocessing steps are undertaken to remove noise, handle missing values, and standardize features. An essential step in driving behavior classification is the extraction of relevant features from the raw data. Various techniques are employed to extract meaningful features from sensor readings, including time-series analysis, frequency-domain analysis, and spatial-temporal patterns. Different types of machine learning algorithms may be used for probabilistic classification of driving behavior patterns, including but not limited to Long Short-Term Memory (LSTM), Gated Recurrent Unit (GRU), Decision Trees, Random Forests, Support Vector Machines (SVM), Neural Networks (NN), K-Nearest Neighbors (KNN), Gradient Boosting and Recurrent Neural Networks (RNN). The machine learning algorithm 58 is trained on a labeled dataset and evaluated using various performance metrics such as accuracy, precision, recall, F1-score, and confusion matrix. The hyperparameters of the models are tuned to achieve optimal results. The machine learning algorithm 58 is trained on training data and will learn to map input features to the corresponding driving behavior probabilities.

In an exemplary embodiment, when the pattern of behavior of the at least one neighboring vehicle 54 is probabilistically classified as either one of aggressive or stalking, the system controller 34A is further adapted to calculate a severity level of the pattern of behavior. For instance, in an exemplary embodiment, the severity level is calculated as a number between zero and five, wherein zero would be low severity and five would be the highest severity. For example, the system controller 34A classifies a neighboring vehicle 54 as exhibiting aggressive behavior based on the number of instances where the neighboring vehicle 54 is following too closely. If the neighboring vehicle was observed by the plurality of onboard sensors 40a-40n to be following too closely five times over a twenty-minute time span, the severity may be calculated at zero or one, wherein, if the neighboring vehicle 54 was observed by the plurality of onboard sensors 40a-40n to be following too closely fifteen times over a twenty-minute time span, the severity may be calculated at four or five. In another example, the system controller 34A classifies a neighboring vehicle 54 as exhibiting aggressive behavior based on the distance at which the neighboring vehicle 54 is following too closely. If the neighboring vehicle 54 was observed by the plurality of onboard sensors 40a-40n to be following too closely, at a distance of twenty feet from the vehicle 10, the severity may be calculated at zero or one, wherein, if the neighboring vehicle 54 was observed by the plurality of onboard sensors 40a-40n to be following too closely, at a distance of five feet from the vehicle 10, the severity may be calculated at four or five. Further, the threshold distances (twenty feet, five feet) would be different when driving in an urban or congested traffic area, where vehicles would inherently be traveling closer together. For example, in a rural setting, a neighboring vehicle would need to be following too closely, at a distance of two feet from the vehicle 10 for the severity to be calculated at four or five. The severity of aggressive or stalking behavior may be calculated based on the rate of occurrences of the behavior or the magnitude of the behavior.

In an exemplary embodiment, when the severity level of the pattern of behavior exceeds a first pre-determined threshold, the system controller 34A is further adapted to initiate passive intervention action. The first pre-determined threshold is set based on preferences received from an occupant within the vehicle 10 via the HMI 50. Such preferences may be set up by the occupant ahead of time, or the system controller 34A may prompt the occupant for preferences each time aggressive or stalking behavior of an identified neighboring vehicle 54 is indicated. For example, the first pre-determined threshold for severity of aggressive or stalking behavior may be set at two, wherein passive intervention will only be initiated upon classification of aggressive or stalking behavior that has a calculated severity of two or more.

In an exemplary embodiment, when initiating passive intervention action, the system controller 34A is further adapted to at least one of: (1) inform the occupant within the vehicle 10 that the neighboring vehicle 54 has been identified as either one of aggressive or stalking, (2) capture, with the plurality of onboard sensors 40a-40n, images of the at least one neighboring vehicle 54, images of a license plate of the at least one neighboring vehicle 54, and images of a driver of the neighboring vehicle 54, (3) collect, with the plurality of onboard sensors 40a-40n, attributes of the at least one neighboring vehicle (color, license plate number, model, manufacturer, car, truck, van, RV) and attributes of the driver (hair color, male, female, race, color of clothing) of the at least one neighboring vehicle 54, (4) lock doors of the vehicle 10, and (5) close windows of the vehicle 10.

Passive intervention includes measures taken in response to relatively low threat aggressive and/or stalking behavior of a neighboring vehicle 54. Passive intervention includes collecting images and data that may be useful evidence if the situation escalates, and steps, such as locking doors and closing windows, that are intended to protect the occupant within the vehicle 10 if the situation does escalate.

In an exemplary embodiment, when the severity level of the pattern of behavior exceeds a second pre-determined threshold, the system controller 34A is further adapted to initiate active intervention action. The second pre-determined threshold is set based on preferences received from an occupant within the vehicle 10 via the HMI 50. Such preferences may be set up by the occupant ahead of time, or the system controller 34A may prompt the occupant for preferences each time aggressive or stalking behavior of an identified neighboring vehicle 54 is indicated. For example, the second pre-determined threshold for severity of aggressive or stalking behavior may be set at four, wherein active intervention will only be initiated upon classification of aggressive or stalking behavior that has a calculated severity of four or more.

In an exemplary embodiment, when initiating active intervention action, the system controller 34A is further adapted to at least one of: (1) alert, via the wireless communication module, emergency services 60 and emergency contacts 62, (2) provide, via the HMI 50, suggested navigation actions to the occupant of the vehicle 10, and (3) autonomously execute, with the vehicle control module 52 in communication with the system controller 34A, navigation actions. Active intervention includes measures taken in response to a relatively high threat of aggressive and/or stalking behavior of a neighboring vehicle 54. Active intervention, in addition to the measures of passive intervention, includes actively taking steps to ask for assistance from emergency contacts 62 and services 60 as well as actively taking evasive/defensive maneuvers, either by the occupant as suggested by the system controller 34A, or, if in an autonomous vehicle, taking evasive/defensive maneuvers autonomously via communication between the system controller 34A and the VCM 52.

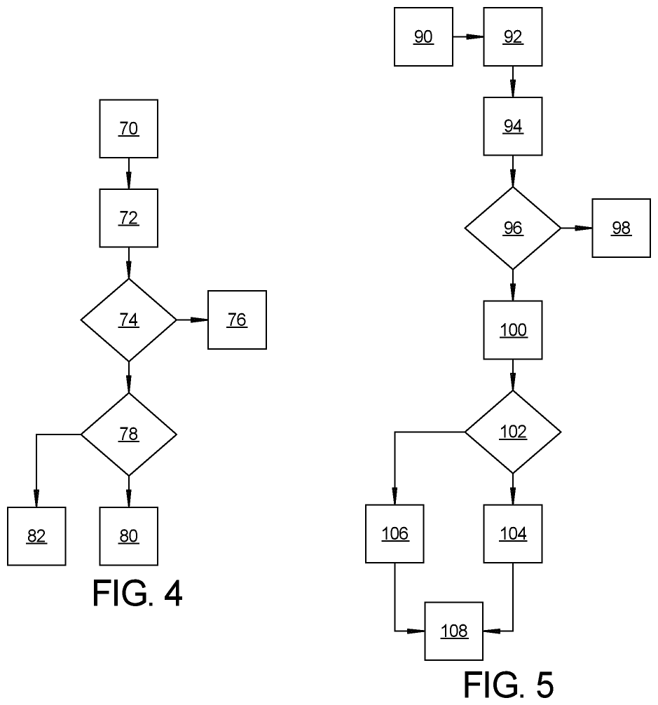

Referring to FIG. 4, by way of a non-limiting example, the system controller 34A has identified a neighboring vehicle 54 that is exhibiting tailgating behavior. Beginning at block 70, the system controller 34A displays information on the HMI 50 to inform an occupant within the vehicle 10 that the neighboring vehicle 54 has been classified as aggressive due to exhibiting tailgating behavior. Moving to block 72, the system controller 34A obtains preferences from the occupant on what the first and second pre-determined thresholds should be, either by accessing preferences entered previously by the occupant, or by receiving real-time input from the occupant in response to prompts from the system controller 34A via the HMI 50. Moving to block 74, the system controller 34A determines if passive or active intervention is called for. If no intervention, or passive intervention is called for, then moving to block 76, the vehicle 10 remains in the same lane and takes no other action. If the severity exceeds the first pre-determined threshold, then passive intervention action at block 76 may further include capturing images of the neighboring vehicle 54 and/or the neighboring vehicle's 54 license plate. If active intervention is called for, then, moving to block 78, the system controller 34A determines if the vehicle 10 is an autonomous vehicle. If the vehicle 10 is an autonomous vehicle, then, moving to block 80, the vehicle 10 automatically and autonomously navigates to an adjacent lane. If the vehicle 10 is not an autonomous vehicle, then, moving to block 82, the system controller 34A provides adjacent lane traffic-based lane change guidance.

Referring to FIG. 5, by way of a non-limiting example, the system controller 34A has identified a neighboring vehicle 54 that is exhibiting stalking behavior. Beginning at block 90, the system controller 34A checks the status of door locks and windows of the vehicle 10, and moving to block 92, displays information on the HMI 50 to inform an occupant within the vehicle 10 that the neighboring vehicle 54 has been classified as aggressive due to exhibiting stalking behavior. Moving to block 94, the system controller 34A obtains preferences from the occupant on what the first and second pre-determined thresholds should be, either by accessing preferences entered previously by the occupant, or by receiving real-time input from the occupant in response to prompts from the system controller 34A via the HMI 50. Moving to block 96, the system controller 34A determines if passive or active intervention is called for. If passive intervention is called for, then moving to block 98, the system controller 34A captures images of the neighboring vehicle 54 and/or the driver of the neighboring vehicle, as well as collects attributes of the neighboring vehicle 54 and/or the driver of the neighboring vehicle 54. If active intervention is called for, then, moving to block 100, the system controller 34A initiates passive intervention, wherein the system controller 34A captures images of the neighboring vehicle 54 and/or the driver of the neighboring vehicle, as well as collects attributes of the neighboring vehicle 54 and/or the driver of the neighboring vehicle 54, and, moving to block 102, the system controller 34A determines if the vehicle 10 is an autonomous vehicle. If the vehicle 10 is an autonomous vehicle, then, moving to block 104, the vehicle 10 automatically and autonomously navigates to a safe location. If the vehicle 10 is not an autonomous vehicle, then, moving to block 106, the system controller 34A provides navigation instructions to a safe location. In either case, moving to block 108, the system controller 34a, via the wireless communication module 36, contacts emergency services to report the stalking to police.

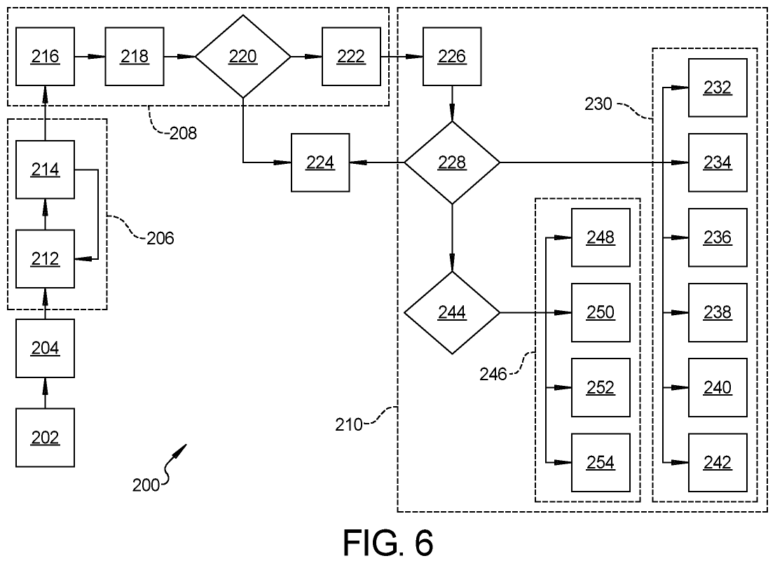

Referring to FIG. 6, a method 200 of monitoring misbehavior of neighboring vehicles and initiating interventions by a vehicle includes, beginning at block 202, identifying, with a plurality of onboard vehicle sensors 40a-40n in communication with a system controller 34A, at least one neighboring vehicle 54, moving to block 204, tagging, with the system controller 34A, the at least one neighboring vehicle 54 with a unique identifier, moving to block 206, monitoring, with the plurality of onboard sensors 40a-40n in communication with the system controller 34A, driving patterns of the at least one neighboring vehicle 54, moving to block 208, classifying, with the system controller 34A, the at least one neighboring vehicle 54, and, moving to block 210, initiating, with the system controller 34A, intervention action.

In an exemplary embodiment, the monitoring, with the plurality of onboard sensors 40a-40n in communication with the system controller 34A, driving patterns of the at least one neighboring vehicle 54 at block 206, further includes monitoring, with the plurality of onboard sensors 40a-40n a relative distance of the at least one neighboring vehicle 54, a relative position of the at least one neighboring vehicle, and a relative speed of the at least one neighboring vehicle.

In another exemplary embodiment, the monitoring, with the plurality of onboard sensors 40a-40n in communication with the system controller 34A, driving patterns of the at least one neighboring vehicle 54 at block 206, further includes, moving to block 212, periodically fusing, with the system controller 34A, data from the plurality of onboard sensors 40a-40n, and, moving to block 214, constructing, with the system controller 34A, a time-series datapoint.

In another exemplary embodiment, the classifying, with the system controller 34A, the at least one neighboring vehicle 54 at block 208, further includes, moving to block 216, identifying, with the system controller 34A, a pattern of behavior of the at least one neighboring vehicle 54, and, moving to block 218, probabilistically classifying, with a machine learning algorithm 58 within the system controller 34A, the pattern of behavior of the at least one neighboring vehicle 54 as one of nominal, aggressive, and stalking.

In still another exemplary embodiment, the probabilistically classifying, with a machine learning algorithm 58 within the system controller 34A, the pattern of behavior of the at least one neighboring vehicle 54 as one of nominal, aggressive, and stalking at block 218 further includes, moving to block 220, when the pattern of behavior of the at least one neighboring vehicle 54 is probabilistically classified as either one of aggressive or stalking, moving to block 222, calculating, with the system controller 34A, a severity level of the pattern of behavior. When the pattern of behavior of the at least one neighboring vehicle 54 is not probabilistically classified as either one of aggressive or stalking, moving to block 224, the method 200 concludes, and no intervention action is taken.

In another exemplary embodiment, the method 200 includes, moving from block 222 to block 226, receiving, with the system controller 34A, via the HMI 50, preferences of the occupant within the vehicle 10 related to the first and second pre-determined thresholds, and setting the first and second pre-determined thresholds based on preferences of the occupant. Moving to block 228, when the severity level of the pattern of behavior exceeds a first pre-determined threshold, the initiating, with the system controller 34A, intervention action at block 210 further includes, moving to block 230, initiating, with the system controller 34A, passive intervention action.

In an exemplary embodiment, the initiating, with the system controller 34A, passive intervention action at block 230, further includes at least one of, moving to block 232, informing, via a vehicle human machine interface (HMI) 50 in communication with the system controller 34A, an occupant within the vehicle 10 of the identification, by the system controller 34A, of the at least one neighboring vehicle 54 that has been classified as either one of aggressive or stalking, moving to block 234, capturing, with the plurality of onboard sensors 40a-40n, images of the at least one neighboring vehicle 54 and images of a license plate of the at least one neighboring vehicle 54, moving to block 236, capturing, with the plurality of onboard sensors 40a-40n, images of a driver of the neighboring vehicle 54, moving to block 238, collect, with the plurality of onboard sensors 40a-40n, attributes of the at least one neighboring vehicle 54 and attributes of the driver of the at least one neighboring vehicle 54, moving to block 240, locking doors of the vehicle 10, and, moving to block 242, closing windows of the vehicle 10.

In still another exemplary embodiment, moving to block 244, when the severity level of the pattern of behavior exceeds a second pre-determined threshold, the initiating, with the system controller 34A, intervention action at block 210 further includes, moving to block 246, initiating, with the system controller 34A, active intervention action.

In yet another exemplary embodiment, the initiating, with the system controller 34A, active intervention action at block 246 further includes at least one of, moving to block 248, alerting, with the system controller 34A, via a wireless communication module 36, emergency services 60, moving to block 250, alerting, with the system controller 34A, via the wireless communication module 36, emergency contacts 62, moving to block 252, providing, with the system controller 34A, via the HMI 50, suggested navigation actions, and, moving to block 254, autonomously executing, with a vehicle control module 52 in communication with the system controller 34A, navigation actions.

A system and method of the present disclosure offers the advantage of monitoring at least one neighboring vehicle and using a machine learning algorithm to probabilistically classify behavior of the at least one neighboring vehicle as normal, aggressive or stalking, and initiating intervention actions based on the type of aggressive or stalking behavior, the severity of the misbehavior and preferences of an occupant. This allows an occupant within a vehicle to get an early indication of suspect behavior by a neighboring vehicle, and when the behavior of the neighboring vehicle escalates, provides for intervention actions to ensure an occupant within the vehicle is safe.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of monitoring misbehavior of neighboring vehicles and initiating interventions by a vehicle, comprising:
identifying, with a plurality of onboard vehicle sensors in communication with a system controller, at least one neighboring vehicle;
tagging, with the system controller, the at least one neighboring vehicle with a unique identifier;
monitoring, with the plurality of onboard sensors in communication with the system controller, driving patterns of the at least one neighboring vehicle;
classifying, with the system controller, the at least one neighboring vehicle; and
initiating, with the system controller, intervention action.

2. The method of claim 1, wherein the monitoring, with the plurality of onboard sensors in communication with the system controller, driving patterns of the at least one neighboring vehicle further includes monitoring, with the plurality of onboard sensors:
a relative distance of the at least one neighboring vehicle;
a relative position of the at least one neighboring vehicle;
a relative speed of the at least one neighboring vehicle; and
a heading direction of the at least one neighboring vehicle.

3. The method of claim 2, wherein the monitoring, with the plurality of onboard sensors in communication with the system controller, driving patterns of the at least one neighboring vehicle further includes:
periodically fusing, with the system controller, data from the plurality of onboard sensors; and
constructing, with the system controller, a time-series datapoint.

4. The method of claim 3, wherein the classifying, with the system controller, the at least one neighboring vehicle further includes:
identifying, with the system controller, a pattern of behavior of the at least one neighboring vehicle; and
probabilistically classifying, with a machine learning algorithm within the system controller, the pattern of behavior of the at least one neighboring vehicle as one of nominal, aggressive, and stalking.

5. The method of claim 4, wherein the probabilistically classifying, with a machine learning algorithm within the system controller, the pattern of behavior of the at least one neighboring vehicle as one of nominal, aggressive, and stalking further includes, when the pattern of behavior of the at least one neighboring vehicle is probabilistically classified as either one of aggressive or stalking, calculating, with the system controller, a severity level of the pattern of behavior.

6. The method of claim 5, wherein, when the severity level of the pattern of behavior exceeds a first pre-determined threshold, the initiating, with the system controller, intervention action further includes initiating, with the system controller, passive intervention action.

7. The method of claim 6, wherein the initiating, with the system controller, passive intervention action further includes at least one of:
informing, via a vehicle human machine interface (HMI) in communication with the system controller, an occupant within the vehicle of the identification, by the system controller, of the at least one neighboring vehicle that has been classified as either one of aggressive or stalking;
capturing, with the plurality of onboard sensors, images of the at least one neighboring vehicle and images of a license plate of the at least one neighboring vehicle;
capturing, with the plurality of onboard sensors, images of a driver of the neighboring vehicle;
collect, with the plurality of onboard sensors, attributes of the at least one neighboring vehicle and attributes of the driver of the at least one neighboring vehicle;
locking doors of the vehicle; and
closing windows of the vehicle.

8. The method of claim 7, wherein, when the severity level of the pattern of behavior exceeds a second pre-determined threshold, the initiating, with the system controller, intervention action further includes initiating, with the system controller, active intervention action.

9. The method of claim 8, wherein the initiating, with the system controller, active intervention action further includes at least one of:
alerting, with the system controller, via a wireless communication module, emergency services;
alerting, with the system controller, via the wireless communication module, emergency contacts;
providing, with the system controller, via the HMI, suggested navigation actions; and
autonomously executing, with a vehicle control module in communication with the system controller, navigation actions.

10. The method of claim 9, further including:
receiving, with the system controller, via the HMI, preferences of the occupant within the vehicle related to the first and second pre-determined thresholds; and
setting the first and second pre-determined thresholds based on preferences of the occupant.

11. A system for monitoring misbehavior of neighboring vehicles and initiating interventions within a vehicle, comprising:
a plurality of onboard vehicle sensors in communication with a system controller, the system controller adapted to:
identify at least one neighboring vehicle;
tag the at least one neighboring vehicle with a unique identifier;
monitor, with the plurality of onboard sensors, driving patterns of the at least one neighboring vehicle;
classify the at least one neighboring vehicle; and
initiate intervention action.

12. The system of claim 11, wherein when monitoring, with the plurality of onboard sensors, driving patterns of the at least one neighboring vehicle the system controller is further adapted to monitor, with the plurality of onboard sensors:
a relative distance of the at least one neighboring vehicle;
a relative position of the at least one neighboring vehicle;
a relative speed of the at least one neighboring vehicle; and
a heading direction of the at least one neighboring vehicle.

13. The system of claim 12, wherein when monitoring, with the plurality of onboard sensors, driving patterns of the at least one neighboring vehicle, the system controller is further adapted to:
periodically fuse data from the plurality of onboard sensors; and
construct a time-series datapoint.

14. The system of claim 13, wherein when classifying the at least one neighboring vehicle, the system controller is further adapted to:
Identify a pattern of behavior of the at least one neighboring vehicle; and
probabilistically classify, with a machine learning algorithm within the system controller, the pattern of behavior of the at least one neighboring vehicle as one of nominal, aggressive, and stalking.

15. The system of claim 14, wherein when probabilistically classifying the pattern of behavior of the at least one neighboring vehicle, and when the pattern of behavior of the at least one neighboring vehicle is probabilistically classified as either one of aggressive or stalking, the system controller is further adapted to calculate a severity level of the pattern of behavior.

16. The system of claim 15, wherein, when the severity level of the pattern of behavior exceeds a first pre-determined threshold, the system controller is further adapted to initiate passive intervention action, wherein the first pre-determined threshold is set according to preferences received from an occupant within the vehicle via a vehicle human machine interface (HMI) in communication with the system controller.

17. The system of claim 16, wherein when initiating passive intervention action, the system controller is further adapted to at least one of:
inform, via the HMI in communication with the system controller, the occupant within the vehicle of the identification, by the system controller, of the at least one neighboring vehicle that has been classified as either one of aggressive or stalking;
capture, with the plurality of onboard sensors, images of the at least one neighboring vehicle, images of a license plate of the at least one neighboring vehicle, and images of a driver of the neighboring vehicle;
collect, with the plurality of onboard sensors, attributes of the at least one neighboring vehicle and attributes of the driver of the at least one neighboring vehicle;
lock doors of the vehicle; and
close windows of the vehicle.

18. The system of claim 17, wherein, when the severity level of the pattern of behavior exceeds a second pre-determined threshold, the system controller is further adapted to initiate active intervention action, wherein the second pre-determined threshold is set according to preferences received from the occupant within the vehicle via the HMI.

19. The system of claim 18, wherein, when initiating active intervention action the system controller is further adapted to at least one of:
alert, via a wireless communication module, emergency services and emergency contacts;
provide, via the HMI, suggested navigation actions; and
autonomously execute, with a vehicle control module in communication with the system controller, navigation actions.

20. A vehicle having a system for monitoring misbehavior of neighboring vehicles and initiating interventions, comprising:
a plurality of onboard vehicle sensors in communication with a system controller, the system controller adapted to:
identify at least one neighboring vehicle;
tag the at least one neighboring vehicle with a unique identifier;
monitor, with the plurality of onboard sensors, driving patterns of the at least one neighboring vehicle, including relative distance, position speed and heading direction of the at least one neighboring vehicle;
periodically fuse data from the plurality of onboard sensors and construct a time-series datapoint;
identify a pattern of behavior of the at least one neighboring vehicle;
probabilistically classify, with a machine learning algorithm within the system controller, the pattern of behavior of the at least one neighboring vehicle as one of nominal, aggressive, and stalking; and
calculate a severity level of the pattern of behavior when the pattern of behavior of the at least one neighboring vehicle is probabilistically classified as either one of aggressive or stalking;
initiate passive intervention action when the severity level of the pattern of behavior exceeds a first pre-determined threshold, the passive intervention action including at least one of:
informing, via the HMI in communication with the system controller, the occupant within the vehicle of the identification, by the system controller, of the at least one neighboring vehicle that has been classified as either one of aggressive or stalking;
capturing, with the plurality of onboard sensors, images of the at least one neighboring vehicle, images of a license plate of the at least one neighboring vehicle, and images of a driver of the neighboring vehicle;
capturing, with the plurality of onboard sensors, attributes of the at least one neighboring vehicle and a driver of the at least one neighboring vehicle;
locking doors of the vehicle; and
closing windows of the vehicle; and
initiate active intervention action when the severity level of the pattern of behavior exceeds a second pre-determined threshold, the active intervention action including at least one of:
alerting, via a wireless communication module, emergency services and emergency contacts;
providing, via the HMI, suggested navigation actions; and
autonomously executing, with a vehicle control module in communication with the system controller, navigation actions.
